(19) United States
(12) Patent Application Publication
(10) Pub. No.: US 2014/0342778 A1
(43) Pub. Date: Nov. 20, 2014

(54) RECHARGEABLE BATTERY FOR MOBILE, PERSONAL DEVICES, SUCH AS MOBILE TELEPHONES, SMARTPHONES, PDAS OR E-READERS

(71) Applicant: Johann Kaspar Locher, Wetzikon (CH)

(72) Inventor: Johann Kaspar Locher, Wetzikon (CH)

(73) Assignee: Swiss Technical Electronic (STE) Holding AG, Vaduz (LI)

(21) Appl. No.: 14/366,206

(22) PCT Filed: Feb. 22, 2012
(86) PCT No.: PCT/EP2012/052982

§ 371 Date: Jun. 17, 2014

(30) Foreign Application Priority Data
Feb. 22, 2011 (AT) A235/2011

(51) Int. Cl. H04M 1/02; H04W 4/00

(52) U.S. Cl. CPC H04M 1/0262; H04W 4/008
USPC 455/558; 455/573

(57) ABSTRACT

Rechargeable battery (4) for mobile, personal devices, such as mobile telephones, smartphones, PDAs or E-readers, which have an internal antenna (1, 9) for electromagnetic near-field communication by means of RFID, NFC or similar standards. The rechargeable battery has an intermediate antenna (2), which communicates contactlessly with the internal antenna (1 or 9), and an external antenna (3), which is connected to the intermediate antenna (2) and communicates towards the outside, wherein the intermediate antenna (2) and the external antenna (3) are applied to two opposite side surfaces of the preferably exchangeable rechargeable battery (4), and the intermediate antenna (2) is arranged in the communication range of the internal antenna (1) when the rechargeable battery has been inserted into the mobile device. The intermediate antenna (2) and the external antenna (3) and the connecting lines (5) thereof are integrated into a label (6) applied to the rechargeable battery (4).

The invention concerns a rechargeable battery for mobile, personal devices, such as mobile telephones, smartphones, PDAs, or e-readers, that have an internal antenna for electromagnetic near field communication by means of RFID, NFC, or similar standards, wherein the rechargeable battery has an intermediate antenna that communicates contactlessly with the internal antenna, and has an external antenna that is connected to the intermediate antenna and communicates towards the outside, wherein the intermediate antenna and the external antenna are applied to two opposite lateral surfaces of the preferably replaceable rechargeable battery, and the intermediate antenna is located in the communication range of the internal antenna when the rechargeable battery is installed in the mobile device.

Antenna arrangements for boosting RFID signals are known from WO 2007/080214 A1, for example. WO 2007/080214 A1 discloses an RFID antenna arrangement having an internal antenna, an intermediate antenna that communicates contactlessly with the internal antenna, and an external antenna that is connected to the intermediate antenna and communicates towards the outside. For spatially limited internal antennas, this arrangement permits a range extension for the electromagnetic near field communication. Range is primarily dependent on the dimensions of the antenna, since the inductive performance of a relatively small antenna is comparatively low. In cases where the internal antenna is integrated into a chip, such as an SMS module, that is installed in the mobile device, a boosting of the range can be achieved with the antenna arrangement from WO 2007/080214 A1, since a large quantity of energy can be received by the (relatively large) external antenna from the electromagnetic field provided for the near field communication, and can be passed on contactlessly to the small internal antenna through the intermediate antenna. One disadvantage of the prior art is the resource-intensive integration of the intermediate and external antennas into the case of the mobile device, where the optimal arrangement of the intermediate antenna in the immediate vicinity of the internal antenna (e.g., directly at the SIM card), oftentimes is not easy to achieve, since other components, such as the rechargeable battery or the chip contact points, need this space.

US2009/0005117 A1 discloses a mobile telephone in which a combination consisting of a rechargeable battery and an antenna arrangement is provided (FIG. 7 through 9 of that document), which essentially has the features of the preamble to claim 1. In this design, the intermediate antenna and the external antenna are mounted on a clip-like carrier that is pushed onto the rechargeable battery from the side. The carrier requires a substantial amount of space in the tightly restricted area available for the rechargeable battery in a mobile telephone, and represents a foreign body that must be taken into account as early as the design of the mobile telephone. A need exists for an improved solution that permits better integration of the antenna arrangement into the structure of a mobile device.

The present invention remedies these and other disadvantages of the prior art by means of a rechargeable battery of the initially mentioned type in which the intermediate antenna and the external antenna and their connecting lines are integrated into a label applied to the rechargeable battery. In this way, optimal power amplification can be achieved with minimum effort. Modification of case parts or other components of the mobile device is avoided. Even the rechargeable battery can remain essentially the same, since it is only supplemented on its outer surface by a flat antenna arrangement implemented as a label. The manufacturing costs are also minimized by the means that conventional rechargeable batteries can be used that are simply provided with a different label.

In one advantageous embodiment, the label can have an absorption-inhibiting material, for example ferrite. Induction-absorbing battery components are shielded in this way.

The invention additionally concerns an antenna arrangement intended for mobile, personal devices, such as mobile telephones, smartphones, PDAs, or e-readers, for electromagnetic near field communication by means of RFID, NFC, or similar standards, having an internal antenna and a rechargeable battery according to the invention, wherein the internal antenna is integrated into a chip card, for example a SIM card, or a memory card, such as an MMC, SD, or micro SD card, that can be inserted into a receptacle of the mobile, personal device. The characteristics of the electromagnetic near field communication, for example the RFID identifier, thus are device-independent and are linked to the chip card. However, the invention can also be used to advantage with an internal antenna that is arranged on any other subassembly of the mobile device. Alternatively, the internal antenna can also be located in an RFID tag that is adhered to the inside surface of the battery receptacle. However, the integration of the internal antenna in a card that can be inserted into the mobile device (e.g., a SIM chip card, MMC memory card, SD memory card, or micro SD memory card) is considered especially advantageous, since it permits linkage of the RFID functionality to software programs stored on the particular card, for example. This can be exploited to good advantage in connection with security, ID, and cryptographic systems, for example.

Another advantageous embodiment of the invention can provide for the internal antenna to be a component of the contact arrangement of the chip card. This ensures economical manufacture of the internal antenna.

In another advantageous embodiment of the invention, the internal antenna can be arranged on the surface of the chip card facing the intermediate antenna. In this way, the distance between the intermediate antenna and internal antenna can be minimized.

In addition, an amplifying case antenna that communicates contactlessly with the external antenna can advantageously be arranged parallel to the external antenna. As a result, the achievable communication range is increased further, since the entire outside surface of the case can be used for the antenna.

In advantageous fashion, a visual identification can be provided on an outer surface of the case of a mobile, personal device having the antenna arrangement according to the invention, where appropriate on a sticker. The visual identification allows a visual verification of the data transmitted via the electromagnetic near field communication, and thus expands the functionality and enhances the security of the near field communication.

Another embodiment of the mobile, personal device can provide for the visual identification to contain an image, personal data, personal characteristics, biometric characteristics, an identification number, an address and/or a telephone number of the user. This makes it possible to verify the association of the RFID data with a specific person, by which means misuse can be prevented.

In another advantageous embodiment of the invention, the visual identification can be a laser engraving. In this way, high security against forgery can be achieved for the visual identification.

Specific features of the invention are now explained in detail using an exemplary embodiment with reference to the attached drawings, where

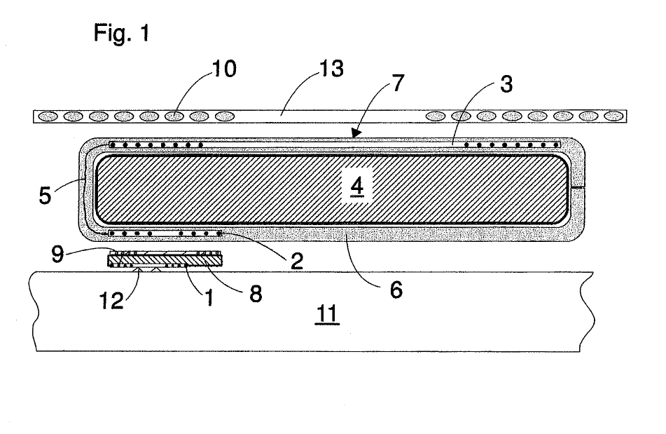

FIG. 1 shows a schematic cross-section through the antenna arrangement according to the invention.

The cross-section shown in FIG. 1 is highly schematic, and explains the arrangement and the interaction of the individual elements of the invention, where the size relationships shown need not necessarily correspond to the actual embodiment of the invention. Depending on the design of the mobile device into which the antenna arrangement is built, the relevant embodiment may vary considerably, with a person skilled in the art being able to adapt the invention to different mobile devices, such as various existing or newly designed mobile telephones, using this description without needing to take an inventive step.

For the sake of simplicity, the mobile device will also be referred to hereinbelow in the context of this description as a mobile telephone, wherein the invention is not restricted thereto, and can also be used to advantage with other mobile devices, such as a smartphone, a radio device, a tablet computer, or a similar device.

Because of its size, the rechargeable battery 4 shown in FIG. 1 usually takes up a significant portion of the available space in the device case of a mobile telephone. Since the rechargeable battery 4 usually has a shorter service life than the mobile device itself, it generally is implemented in replaceable form. For example, the rechargeable battery 4 in many devices is inserted into a receptacle on the back of the case that is closed with a case cover 13. In most cases, the connection between the rechargeable battery 4 and the rest of the mobile device's electronic components 11 is established by means of mechanical contacts.

As in the embodiment shown, a receptacle for a chip card 8, in particular a SIM card, is provided below the rechargeable battery 4 in most mobile telephones. The information stored on the chip card 8 includes all personal or contract-related data needed to enable the applicable network operator to allocate and bill for the communications services. As a result, it is possible—as is generally known—to use different mobile telephones or mobile devices with the same chip card, or simply to change to another device. All that is necessary is to remove the SIM card from the old device and insert it into the new device. The invention is not restricted to SIM cards alone, but can instead be implemented with all chip cards that offer corresponding functionality. For example, the chip card could be a memory card equipped with an RFID antenna, such as a micro SD card, on which are stored all relevant personal or contract-related data and, if applicable, programs that can run on the mobile device (cryptography programs, for example).

Integrated in the chip card 8 is an internal antenna 1 for electromagnetic near field communication that can be used even without its own power supply. Such antennas are known as RFID antennas, where different standards, such as NFC or the like, may also be employed. In this context, the internal antenna can be integrated into the chip card's contact arrangement, as is already known in the prior art. In this case, free contacts that are not used by the SIM card are connected to the RFID antenna and/or are scaled up to antenna size. Inside the card, the contacts are connected to an electronic chip on which the RFID applet runs (separately from the functionality of the SIM card).

When the chip card 8 has been inserted into the device properly, the contact arrangement of the chip card 8 makes contact with corresponding contacts 12 of the mobile device, establishing a connection with the remaining electronic components 11 of the mobile device. The result that is produced (as can also be seen in FIG. 1) in general is an arrangement in which the RFID antenna (internal antenna 1) of the chip card is installed between the electronic components 11 of the mobile device on one side and the chip card 8, rechargeable battery 4, and case cover 13 on the other side, and is electromagnetically shielded thereby. This reduces the antenna range, which is not desirable.

Moreover, the amount of space on the chip card 8 is very limited, so only a relatively small RFID antenna can be provided, which also has an adverse effect on the antenna's range. As is known, the achievable range of an RFID antenna is directly proportional to the size of the antenna in terms of area.

The size of the antenna can be extended to the size of the chip card 8, at a maximum, with it also being possible to provide an additional internal antenna 9, which can be located on the side of the chip card opposite the contacts 12. However, this antenna 9 (which is not mandatory according to the invention) is also restricted in size to the dimensions of the chip card 8.

In order to extend the range of the antenna(s), according to the invention an intermediate antenna 2 is provided on the lateral surface of the rechargeable battery 4 facing the chip card 8; this antenna is essentially parallel to the internal antenna 1 or 2, and communicates contactlessly therewith. The intermediate antenna 2 is connected by connecting lines 5 to an external antenna 3, which is arranged on the outward-facing lateral surface of the rechargeable battery 4. This external antenna 3 can thus extend over the entire area of the battery's external surface, and consequently also can receive a relatively weak RFID signal and relay it to the internal antenna. The principle of this antenna amplification is known from the prior art to those skilled in the art, and is described in detail in WO 2007/080214, for example.

The intermediate antenna 2 and the external antenna 3 are integrated into a label 6, which is affixed to the rechargeable battery 4. The thickness of the label 6 is exaggerated in the illustration in FIG. 1. In actuality, the thickness of the label 6 with the antennas 2 and 3 located therein differs very little or not at all from the label typically used to cover rechargeable batteries. As a result, there is no need to make complex provisions when designing the device in order to implement the invention. Moreover, the invention can be employed to good advantage in existing devices simply by replacing the old rechargeable battery with a new one, or by adding a corresponding label 6 to the old battery.

In addition, it is advantageous that the external antenna 3 is located directly beneath the case cover 13, which shields the antenna only negligibly. The electronic components 11 and the rechargeable battery 4 hinder RFID communication only to a slight degree. In addition, absorption-inhibiting materials such as ferrite can be provided in the label 6 in order to shield induction-absorbing components of the rechargeable battery.

In the embodiment shown, an additional antenna, the case antenna 10, is located in the case cover 13. The case antenna 10 is galvanically isolated from the external antenna 3 and communicates contactlessly with it. In this way, the antenna area, which is critical for the range of the antenna arrangement, can be enlarged still further. In this context, the case antenna 10 can either be integrated into the case cover 13, or be applied to the outside or inside of the same, for example by means of a label.

For security-related applications, such as in payment functionalities or access control systems, in which identification of the owner of the mobile device takes place contactlessly by means of the chip card's RFID applet, security can be enhanced substantially by the means that a visual identification is applied to the case of the mobile device. The visual identification can be a simple label on which is printed an image, personal data, personal characteristics, biometric characteristics, an identification number, an address and/or a telephone number of the user. The visual identification makes it possible, in order to prevent misuse by third parties, to verify the identity of the owner of the mobile device who is using the RFID functionality to identify himself. To make forgery of the label more difficult, the label can be provided with forgery-resistant features such as a laser engraving. Oftentimes it is sufficient in this context to delay forgery of the visual identification for only a relatively short time, since the loss of an item such as a mobile telephone generally is noticed very quickly, and the corresponding identification functionalities can be blocked before the forged label is produced and misuse is possible.

Alternatively, the visual identification can also be provided directly on the case of the mobile device, without a label, preferably on the case cover of the mobile device, for example by means of (laser) engraving.
internal antenna (1, 9)
intermediate antenna (2)
external antenna (3)
rechargeable battery (4)
connecting lines (5)
label (6)
visual identification (7)
chip card (8)
case antenna (10)
electronic components 11
contacts 12
case cover 13

1-6. (canceled)

7. Mobile, personal device, such as a mobile telephone, smartphone, PDA, or e-reader, that has an internal antenna for electromagnetic near field communication by means of RFID, NFC, or similar standards, and has a rechargeable battery, wherein the rechargeable battery has an intermediate antenna that communicates contactlessly with the internal antenna, and has an external antenna that is connected to the intermediate antenna and communicates towards the outside, wherein the intermediate antenna is applied to one lateral surface and the external antenna is applied to the opposite lateral surface of the preferably replaceable rechargeable battery, and wherein the intermediate antenna is located in the communication range of the internal antenna when the rechargeable battery is installed in the mobile device, wherein the intermediate antenna and the external antenna and their connecting lines are integrated into a label applied to the rechargeable battery, wherein an amplifying case antenna that communicates contactlessly with the external antenna is arranged parallel to the external antenna.

8. Mobile, personal device according to claim 7, wherein the label has an absorption-inhibiting material, for example ferrite.

9. Mobile, personal device according to claim 7, wherein the internal antenna is integrated into a chip card, for example a SIM card, or a memory card, such as an MMC, SD, or micro SD card, that can be inserted into a receptacle of the mobile, personal device.

10. Mobile, personal device according to claim 9, wherein the internal antenna is a component of the contact arrangement of the chip card.

11. Mobile, personal device according to claim 9, wherein the internal antenna is arranged on the surface of the chip card facing the intermediate antenna.
